(19) United States
(12) Patent Application Publication
(10) Pub. No.: US 2024/0238717 A1
(43) Pub. Date: Jul. 18, 2024

(54) DIRECT AIR CAPTURE DEVICE AND CARBON DIOXIDE CAPTURE METHOD

(71) Applicant: TOYOTA JIDOSHA KABUSHIKI KAISHA, Toyota-shi (JP)

(72) Inventor: Takahiro SADAMITSU, Miyoshi-shi (JP)

(73) Assignee: TOYOTA JIDOSHA KABUSHIKI KAISHA, Toyota-shi (JP)

(21) Appl. No.: 18/480,840

(22) Filed: Oct. 4, 2023

(30) Foreign Application Priority Data
Jan. 12, 2023 (JP) 2023-003128

(51) Int. Cl. B01D 53/04

(52) U.S. Cl. CPC B01D 53/0438; B01D 2253/202; B01D 2253/3425; B01D 2257/504; B01D 2258/06; B01D 2259/40096

(57) ABSTRACT

A direct air capture device according to one aspect of the present disclosure includes a carrier with a carbon dioxide adsorbent supported thereon. The direct air capture device electrically heats the carrier when desorbing the carbon dioxide adsorbed by the carbon dioxide adsorbent. Since the direct air capture device according to one aspect of the present disclosure electrically heats the carrier without using a heat medium, heat is not lost from the heat medium to a pipe or the like, and the heating efficiency is excellent.

### CROSS-REFERENCE TO RELATED APPLICATION

This application claims priority to Japanese Patent Application No. 2023-003128 filed on Jan. 12, 2023, incorporated herein by reference in its entirety.

### BACKGROUND

### 1. Technical Field

The present disclosure relates to direct air capture devices and carbon dioxide capture methods.

### 2. Description of Related Art

Japanese Unexamined Patent Application Publication (Translation of PCT Application) No. 2014-516771 (JP 2014-516771 A) discloses a direct air capture (DAC) device having a reaction channel and a heat exchange channel. The reaction channel contains a carbon dioxide adsorbent in its wall. A heat medium for heating or cooling the reaction channel flows through the heat exchange channel.

### SUMMARY

The inventors found the following problem with the DAC device disclosed in JP 2014-516771 A. In the DAC device disclosed in JP 2014-516771 A, the reaction channel is heated by causing the heat medium to flow through the heat exchange channel. Therefore, heat is inevitably lost to a pipe through which the heat medium flows, which results in poor heating efficiency.

The present disclosure was made in view of such circumstances, and provides a direct air capture device and a carbon dioxide capture method that are excellent in heating efficiency.

A direct air capture device according to an aspect of the present disclosure includes a carrier with a carbon dioxide adsorbent supported on the carrier. The direct air capture device is configured to electrically heat the carrier when desorbing carbon dioxide adsorbed by the carbon dioxide adsorbent.

A carbon dioxide capture method according to an aspect of the present disclosure includes the steps of: passing air through a carrier with a carbon dioxide adsorbent supported on the carrier to cause the carbon dioxide adsorbent to adsorb carbon dioxide; and heating the carrier to desorb and capture the carbon dioxide adsorbed by the carbon dioxide adsorbent. The carrier is electrically heated in the step of desorbing the carbon dioxide.

In the above aspect of the present disclosure, the carrier is electrically heated when desorbing the carbon dioxide adsorbed by the carbon dioxide adsorbent. That is, since the carrier is electrically heated without using any heat medium, heat is not lost from the heat medium to a pipe etc. Therefore, excellent heating efficiency is provided.

The carrier may be made of metal or may be made of an electrically conductive ceramic material. With such a configuration, the carrier can be easily electrically heated.

The carrier may be porous. With such a configuration, carbon dioxide can be adsorbed with high efficiency.

The present disclosure can provide a direct air capture device and a carbon dioxide capture method that are excellent in heating efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a direct air capture device according to a first embodiment;

FIG. 2 is a plan view seen from directly above the surface electrode 20 in FIG. 1;

FIG. 3 is a cross-sectional view of the direct air capture device along the line III-III in FIG. 2, showing the adsorption process in a non-energized state; and

FIG. 4 is a cross-sectional view of the direct air capture device taken along line III-III in FIG. 2, showing the desorption process in an energized state.

### DETAILED DESCRIPTION OF EMBODIMENTS

Hereinafter, specific embodiments of the present disclosure will be described in detail with reference to the drawings. However, the present disclosure is not limited to the following embodiments. Also, for clarity of explanation, the following description and drawings are simplified as appropriate.

### 1st Embodiment

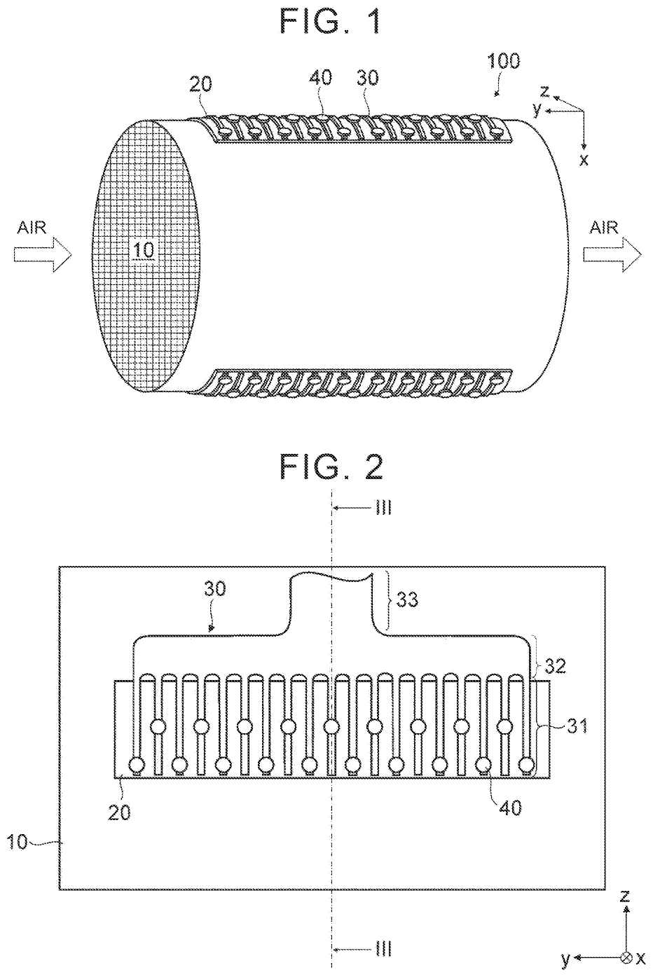

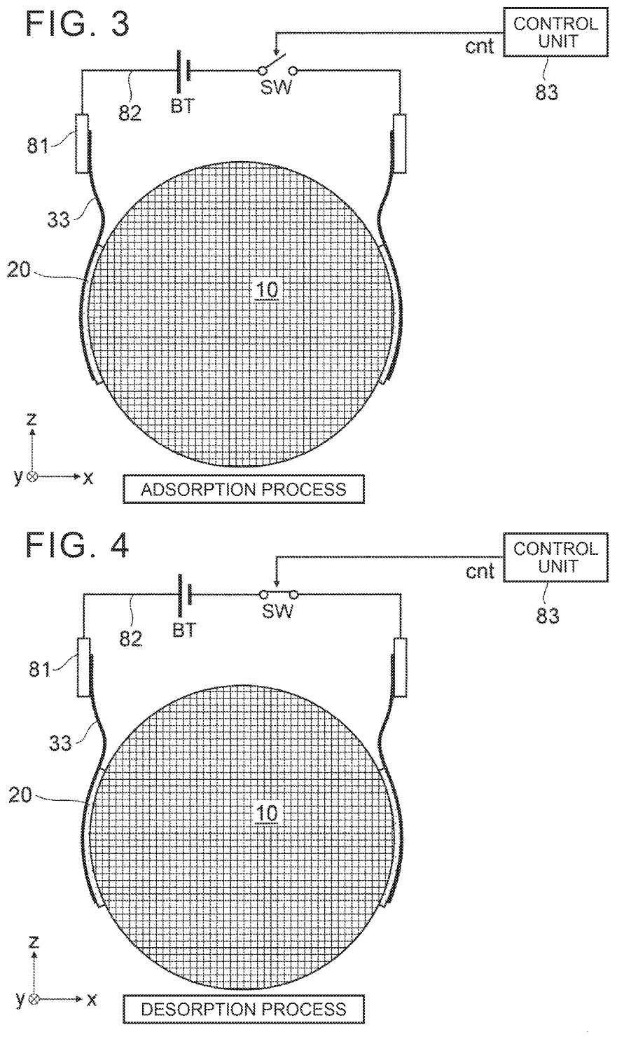

First, a direct air capture device according to a first embodiment will be described with reference to FIGS. 1 to 4. FIG. 1 is a perspective view of a direct air capture device according to the first embodiment. FIG. 2 is a plan view seen from directly above the surface electrode 20 (minus side in the x-axis direction) in FIG. 1. FIG. 3 is a cross-sectional view of the direct air capture device taken along line III-III in FIG. 2. FIG. 3 shows the adsorption process in a non-energized state. FIG. 4 is a cross-sectional view of the direct air capture device taken along line III-III in FIG. 2. FIG. 4 shows the desorption process in the energized state.

It should be noted that, of course, the right-handed xyz coordinates shown in the drawings are for convenience in describing the positional relationship of the constituent elements. The xyz coordinates in each drawing are common. The y-axis direction is the axial direction of the carrier 10.

A direct air capture device 100 is a device that passes air through a carrier 10 with a carbon dioxide adsorbent supported thereon and capture carbon dioxide in the air by allowing the carbon dioxide adsorbent to adsorb the carbon dioxide. The direct air capture device 100 can be electrically heated. Therefore, as shown in FIG. 1, the direct air capture device 100 includes surface electrodes 20, wiring members 30 and fixing layers 40 on the outer peripheral surface of the carrier 10. Note that the surface electrode 20, the wiring member 30, and the fixing layer 40 are merely an embodiment for enabling the carrier 10 to be electrically heated, and are not limited in any way.

Note that FIG. 2 shows the positional relationship of one surface electrode 20 with the carrier 10, the wiring member 30, and the fixing layer 40. The same applies to the other surface electrode 20. Specifically, as shown in FIGS. 1 and 3, the two surface electrodes 20 are in a positional relationship of mirror symmetry with respect to a plane of symmetry parallel to the yz plane.

The carrier 10 is, for example, a porous member and carries a carbon dioxide adsorbent thereon. Carrier 10 need not be porous. However, when the carrier 10 is porous, the surface area in contact with air is increased, and carbon dioxide can be adsorbed with high efficiency. Further, since the carrier 10 itself is electrically heated, the carrier 10 is made of an electrically conductive ceramic material such as SiC (silicon carbide). The carrier 10 maybe made of metal such as nichrome or stainless steel. Examples of the carbon dioxide adsorbent include polyethyleneimine, primary amines, secondary amines, and secondary alkanolamines.

As shown in FIG. 1, the carrier 10 has, for example, a substantially cylindrical outer shape. The inside of the carrier 10 has a honeycomb structure composed of a plurality of channels extending in the y-axis direction. Air passes through the inside of the carrier 10 in the axial direction (y-axis direction), as indicated by the hollow arrow.

The surface electrodes 20 are a pair of electrodes formed on the outer peripheral surface of the carrier 10 and arranged to face each other with the carrier 10 interposed therebetween, as shown in FIG. 1. The surface electrode 20 is in physical contact with and electrically connected to the carrier 10. Moreover, as shown in FIG. 2, each surface electrode 20 has, for example, a rectangular planar shape. Each surface electrode 20 extends, for example, in the carrier axis direction (y-axis direction).

Furthermore, as shown in FIGS. 3 and 4, the surface electrode 20 is electrically connected to the battery BT via the wiring member 30, the external electrode 81, and the external wiring 82. With such a configuration, current is supplied to the entire carrier 10. Thereby, the carrier 10 is uniformly electrically heated. One of the pair of surface electrodes 20 is a plus pole and the other is a minus pole. Any surface electrode 20 maybe a positive electrode or a negative electrode. In other words, the direction of current flowing through the carrier 10 is not limited.

The surface electrode 20 is, for example, a thermal spray coating formed by plasma thermal spraying. The thickness of the surface electrode 20 is, for example, approximately 50 to 200 μm. The surface electrode 20 is energized in the same manner as the wiring member 30. Therefore, this thermal spray coating must be metal-based. Examples of the metal that constitutes the matrix of the thermal spray coating include copper, aluminum, and alloys thereof having high electrical conductivity.

The wiring members 30 are arranged on the respective surface electrodes 20, as shown in FIGS. 1 and 2. As shown in FIG. 2, the wiring member 30 includes a comb-like wiring 31, a root portion 32 and a lead portion 33. Details of each will be described later. The entire wiring member 30 is, for example, a thin metal plate having a thickness of about 0.1 mm. Also, the wiring member 30 is made of copper, aluminum, an alloy thereof, or the like having high conductivity.

As shown in FIG. 2, the plurality of comb-like wirings 31 extend in the circumferential direction of the carrier over substantially the entire region where the surface electrode 20 is formed. A plurality of comb-tooth-shaped wirings 31 are arranged side by side at approximately equal intervals along the carrier axis direction (y-axis direction). Furthermore, all of the comb-like wirings 31 are connected to the root portion 32 on the positive side in the z-axis direction of the surface electrode 20 formation region. All of the comb-like wirings 31 are fixed to the surface electrode 20 by the fixing layer 40. All of the comb-like wirings 31 are electrically connected to the surface electrodes 20. As a matter of course, the width and the number of the comb-shaped wirings 31 are appropriately determined.

As shown in FIG. 2, the root portion 32 is a portion extending along the surface electrode 20 in the carrier axial direction (y-axis direction). All of the comb-like wirings 31 are extended from the root portion 32 in the circumferential direction of the carrier. The root portion 32 is not fixed to the carrier 10 and the surface electrode 20. The lead-out portion 33 is provided on the side opposite to the comb-like wiring 31 in the central portion of the root portion 32 in the carrier axial direction (y-axis direction). The lead portion 33 is also not fixed to the carrier 10 and the surface electrode 20.

The fixing layer 40 is a button-shaped thermal spray coating formed on the comb-like wiring 31. A wiring member 30 is arranged on the surface electrode 20. The fixing layer 40 can be formed by arranging a masking jig thereon and performing plasma spraying. The material forming the fixing layer 40 is the same as that of the surface electrode 20 described above. By sandwiching the comb-like wiring 31 between the fixing layer 40 and the surface electrode 20, the comb-like wiring 31 is fixed and electrically connected to the surface electrode 20.

In the example of FIG. 2, each comb-like wiring 31 is fixed to the surface electrode 20 by one fixing layer 40. In other words, the comb-like wiring 31 is not fixed to the surface electrode 20 at the portion where the fixing layer 40 is not formed. With such a configuration, thermal strain (thermal stress) due to the difference in linear expansion coefficient between the wiring member 30 made of the thin metal plate and the carrier 10 made of ceramics can be relaxed. In other words, the thermal strain (thermal stress) can be alleviated by forming the individual fixing layers 40 as small as possible and by interspersing them. The number and spacing of the fixing layers 40 to be arranged may be determined as appropriate.

As shown in FIGS. 3 and 4, the wiring member 30 (lead portion 33) is electrically connected to the battery BT via the external electrode 81 and the external wiring 82. With such a configuration, an electric current is supplied to the carrier 10, and the carrier 10 is electrically heated. Here, the battery BT is connected in series with the switch SW. A control unit 83 controls on/off of the switch SW by a control signal cnt. That is, the control unit 83 controls energization and non-energization of the carrier 10.

FIG. 3 shows the carbon dioxide adsorption process when the switch SW is off, that is, in a non-energized state (non-heating state). On the other hand, FIG. 4 shows the desorption process of the adsorbed carbon dioxide when the switch SW is on, that is, in an energized state (heating state). The heating temperature of the carrier 10 in the desorption step is, for example, about 100° C.

In the carbon dioxide capture method using the direct air capture device 100, the adsorption step shown in FIG. 3 and the desorption step shown in FIG. 4 are repeated. When shifting from the desorption step to the adsorption step, air is introduced into the inside of the carrier 10 to cool the carrier 10 as in the adsorption step. Thereby, it is possible to quickly shift to the adsorption step.

As described above, in the direct air capture device 100 according to the present embodiment, the carrier 10 is electrically heated when the carbon dioxide adsorbed by the carbon dioxide adsorbent is desorbed. That is, the carrier 10 is electrically heated without using a heat medium. Therefore, heat is not lost from the heat medium to a pipe etc., and the heating efficiency is excellent.

It should be noted that the present disclosure is not limited to the above embodiments, and can be modified as appropriate without departing from the spirit of the present disclosure. Also, the present disclosure contributes to carbon neutrality, decarbonization, and Sustainable Development Goals (SDGs).

What is claimed is:

1. A direct air capture device, comprising a carrier with a carbon dioxide adsorbent supported on the carrier, wherein the direct air capture device is configured to electrically heat the carrier when desorbing carbon dioxide adsorbed by the carbon dioxide adsorbent.

2. The direct air capture device according to claim 1, wherein the carrier is made of metal.

3. The direct air capture device according to claim 1, wherein the carrier is made of an electrically conductive ceramic material.

4. The direct air capture device according to claim 1, wherein the carrier is porous.

5. A carbon dioxide capture method, comprising the steps of:
passing air through a carrier with a carbon dioxide adsorbent supported on the carrier to cause the carbon dioxide adsorbent to adsorb carbon dioxide; and
heating the carrier to desorb and capture the carbon dioxide adsorbed by the carbon dioxide adsorbent, wherein the carrier is electrically heated in the step of desorbing the carbon dioxide.
